(19) United States
(12) Patent Application Publication
(10) Pub. No.: US 2006/0042308 A1
(43) Pub. Date: Mar. 2, 2006

(54) Air conditioner for vehicle use

(75) Inventors: Shin Nishida, Anjo-city (JP); Syuichi Mizuno, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/153,139

(22) Filed: Jun. 15, 2005

(30) Foreign Application Priority Data
Jun. 18, 2004 (JP) 2004-181082

(51) Int. Cl. F25B 43/00; B60H 3/00; B61D 27/00

(52) U.S. Cl. 62/503; 165/42

(57) ABSTRACT

The internal heat exchanger 15 for exchanging heat between the refrigerant, which has passed through the gas cooler 11 for cooling the refrigerant, and the refrigerant, which is before the suction into the compressor 10, are arranged in a space on the rear side of the fan shroud 32 with respect to the vehicle and on the outer circumferential side of the blower 31. As a space which has not been conventionally put into effective use is utilized, it is unnecessary to ensure a new space for arranging the internal heat exchanger 15 in the engine compartment.

### BACKGROUND OF THE INVENTION

1. Field of the Invention

The present invention relates to an air conditioner, for vehicle use, having an internal heat exchanger to exchange heat between the refrigerant in a refrigerating cycle.

2. Description of the Related Art

The performance of heat exchangers, which are incorporated into cooling units and air conditioners for vehicle use, has been enhanced yearly and, further, the heat exchangers have been downsized yearly. On the other hand, as the functions of vehicles have been enhanced and have been made complicated, the number of the required heat exchangers has increased and, further, the radiating capacity of the heat exchangers has been increased.

According to an increase in the number of functional parts to be mounted on vehicles and also according to the necessity of enhancing the safety of the vehicles in the case of car collision, concerning the positions at which the functional parts are mounted in the engine compartments of the vehicles, the conditions have become severe. Especially, concerning the position at which the newly added heat exchanger is arranged, it becomes difficult to provide a position in the engine compartment.

In the case of an air conditioner, the refrigerant of which is carbonic acid gas, which has been recently been developed, it is indispensable to provide an internal heat exchanger in which heat is exchanged between the refrigerant, which has passed through a radiator, and the refrigerant, before suction into a compressor, so that the efficiency of the refrigerating cycle can be enhanced. Due to the aforementioned restriction imposed on the vehicle side, the method of mounting the internal heat exchanger on the vehicle affects not only the installation but also the manufacturing cost of the entire air conditioning system.

In order to solve the above problems of installing the internal heat exchanger, the following several proposals have been made. For example, the official gazettes of JP-A-2002-20682 and JP-A-10-176891 disclose an installation of the internal heat exchanger which is built in an accumulator for storing liquid phase refrigerant. The official gazette of JP-A-2000-318432 discloses an installation of the internal heat exchanger in which the radiator for cooling refrigerant discharged from a compressor and the internal heat exchanger are integrated into one body. Further, the official gazette of JP-A-2000-97504 discloses an installation of the internal heat exchanger in which the internal heat exchanger is integrated with the accumulator and the radiator into one body.

However, the following problems have been encountered. In the case of a device in which the internal heat exchanger is built into the accumulator, an arrangement of the piping of the refrigerating cycle can be simplified. However, when the heat exchanger is provided in the accumulator, the accumulator itself is much larger in size.

In the device in which the radiator and the internal heat exchanger are integrated into one body, as the internal heat exchanger is arranged at the same position as that of the radiator, the property of installation is excellent. However, as the internal heat exchanger is arranged in parallel with a current of air, a front area of the radiator is restricted by the internal heat exchanger, and the radiating performance of the radiator is deteriorated.

Furthermore, in the device in which the internal heat exchanger is integrated with the accumulator and the radiator into one body, both the problems described above are caused, that is, the size of the accumulator is extended and, further, the radiating performance of the radiator is deteriorated.

### SUMMARY OF THE INVENTION

In view of the above points, it is an object of the present invention to enhance the installation property of an internal heat exchanger without making an accumulator larger or deteriorating the radiating performance of a radiator.

In order to achieve the above object, the present invention provides an air conditioner, for vehicle use, mounted on a vehicle, the vehicle including: a radiator (30) for cooling coolant by exchanging heat between the coolant, which has cooled a water-cooled engine, and the outside air; a blower (31) for generating a current of air, arranged on the rear side of the radiator (30) with respect to the vehicle; and a fan shroud (32), which covers an outer circumferential side of the blower (31), for guiding the current of air so that the current of air generated by the blower (31) can pass through the radiator (30), the air conditioner for a vehicle comprising: a compressor (10) for sucking and compressing refrigerant in a refrigerating cycle; a gas cooler (11) for cooling refrigerant by exchanging heat between the refrigerant, which has been discharged from the compressor (10), and the outside air; and an internal heat exchanger (15) for exchanging heat between the refrigerant, which has passed through the gas cooler (11), and the refrigerant before it is sucked into the compressor (10), wherein at least a portion of the internal heat exchanger (15) is arranged in a space on the rear side of the fan shroud (32) with respect to the vehicle and on the outer circumferential side of the blower (31).

Due to the above constitution, it is possible to utilize a space which has not been conventionally used. Therefore, it becomes unnecessary to ensure a new space in the engine room in order to install the internal heat exchanger.

According to the above constitution, the internal heat exchanger is not integrated with the accumulator and the radiator into one body. Therefore, the installation property of the internal heat exchanger can be enhanced without extending the size of the accumulator and deteriorating the radiating performance of the radiator.

According to the present invention, when a plurality of blowers (31) are provided, at least a portion of the internal heat exchanger (15) is arranged between the plurality of blowers (31).

Further, according to the present invention, at least a portion of the internal heat exchanger (15) may be arranged outside the blower (31) in the width direction of the vehicle. Alternatively, at least a portion of the internal heat exchanger (15) may be arranged in an upper portion or a lower portion of the blower (31).

Further, according to the present invention, the internal heat exchanger (15) includes a heat exchanging section (150, 151, 152) having a passage, in which the refrigerant of high temperature flows, and also having a passage, in which the refrigerant of low temperature flows, and the heat exchanging section (150, 151, 152) is made by means of extruding or drawing.

Due to the foregoing, the pressure resistance of the heat exchanging section, which is formed by means of extruding or drawing, is high. Therefore, the thus formed heat exchanging section is preferably used for an internal heat exchanger to which CO₂ cycle is applied in which the refrigerant pressure is high.

Further, according to the present invention, the heat exchanging section (150) may be formed into a cylindrical shape. Furthermore, the heat exchanging section (151, 152) may be formed into a plate shape. Furthermore, the heat exchanging section (152) can be composed of a plurality of plate-shaped heat exchanging section composing members (152) which are joined to each other.

Furthermore, an air conditioner for vehicle use according to the present invention comprises an accumulator (14) in which refrigerant is separated into gas-phase refrigerant and liquid-phase refrigerant and the separated liquid-phase refrigerant is stored, wherein at least one portion of the accumulator (14) is arranged in a space on the rear side of the fan shroud (32) with respect to the vehicle and on the outer circumferential side of the blower (31).

Due to the foregoing, a dead space on the rear side of the fan shroud can be more effectively utilized.

Furthermore, according to the present invention, the accumulator (14) and the heat exchanger (15) are directly connected to each other by a connector (40).

Due to the foregoing, the refrigerant at the outlet of the accumulator can be directly guided onto the low pressure side of the internal heat exchanger. Therefore, the refrigerating system can be greatly simplified.

In this connection, reference numerals, in parentheses, for each means correspond to the specific means in the embodiment described later.

The present invention may be more fully understood from the description of preferred embodiments of the invention, as set forth below, together with the accompanying drawings.

### BRIEF DESCRIPTION OF THE DRAWINGS

FIG. 1 is a schematic illustration showing a model of the constitution of the air conditioner for vehicle use of the first embodiment of the present invention.

FIG. 2 is a view showing the air conditioner for vehicle use of the first embodiment, wherein the view is taken from the side of a vehicle.

FIG. 3 is a perspective view showing the air conditioner for vehicle use of the first embodiment, wherein the view is taken from the oblique rear of a vehicle.

FIG. 4 is a perspective view showing a sectional structure of the heat exchanging section of the internal heat exchanger 15 shown in FIG. 1.

FIG. 5 is a view showing the air conditioner for vehicle use of the second embodiment, wherein the view is taken from the side of a vehicle.

FIG. 6 is a side view showing the right of FIG. 5.

FIG. 7 is a view showing the air conditioner for vehicle use of the third embodiment, wherein the view is taken from the side of a vehicle.

FIG. 8 is a side view showing the right of FIG. 7.

FIG. 9 is a view showing the air conditioner for vehicle use of the fourth embodiment, wherein the view is taken from the side of a vehicle.

FIG. 10 is a side view showing the right of FIG. 9.

FIG. 11 is a view showing the air conditioner for vehicle use of the fifth embodiment, wherein the view is taken from the side of a vehicle.

FIG. 12 is a side view showing the right of FIG. 11.

FIG. 13 is a perspective view showing the air conditioner for vehicle use of the sixth embodiment, wherein the view is taken from the oblique rear of a vehicle.

FIG. 14 is a perspective view showing a sectional structure of the heat exchanging section of the air conditioner for vehicle use of the seventh embodiment.

FIG. 15 is a perspective view showing a sectional structure of the heat exchanging section of the air conditioner for vehicle use of the eighth embodiment.

### DESCRIPTION OF THE PREFERRED EMBODIMENTS

### First Embodiment

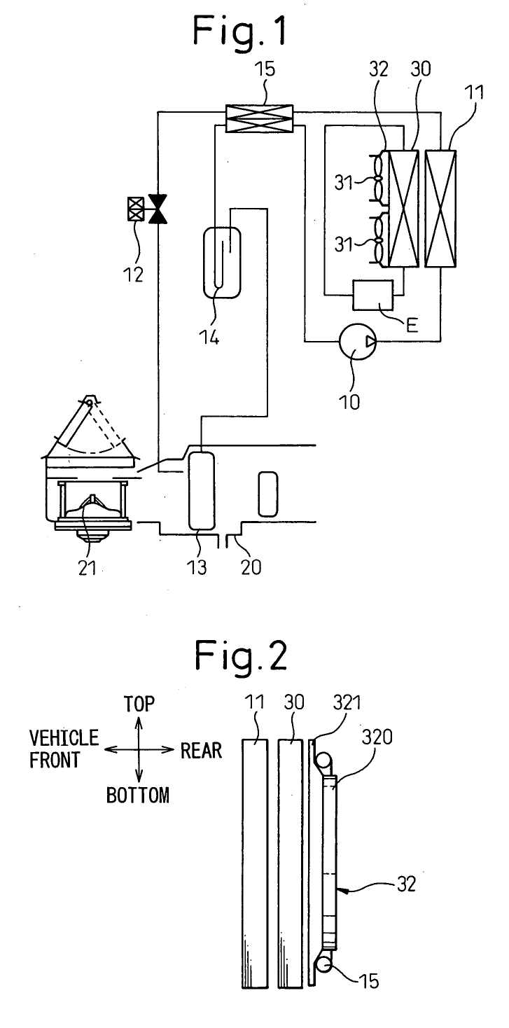

FIG. 1 is a schematic illustration showing a model of the constitution of the air conditioner for vehicle use of the first embodiment of the present invention. The refrigerating cycle of this air conditioner for vehicle use is composed of a CO₂ cycle in which CO₂ is used as refrigerant.

The compressor 10 is driven by water-cooled engine E mounted on a vehicle. The compressor 10 sucks refrigerant (CO₂) and compresses the thus sucked refrigerant to a pressure not lower than the critical pressure.

The gas cooler 11 is connected to the discharge side of the compressor 10 and exchanges heat between the refrigerant (refrigerant of high pressure), which has been discharged from the compressor 10, and the outside air so that the discharged refrigerant can be cooled.

The expansion valve 12 is composed of a variable throttle mechanism and connected to the outlet side of the gas cooler 11. The expansion valve 12 decompresses the refrigerant of high pressure, which has been discharged from the gas cooler 11, to a two-phase state containing gas and liquid at low temperature and low pressure.

The evaporator 13 is connected to the outlet side of the expansion valve 12 and installed in the interior air conditioning unit 20. This interior air conditioning unit 20 is arranged inside the instrument panel provided in the vehicle room. This interior air conditioning unit 20 adjusts the temperature of a flow of air, which is sent from the air conditioning fan 21 composed of a fan and electric motor, and flows out the blast of air into the vehicle room. In the evaporator 13, the refrigerant of low pressure absorbs heat from the blast of air and evaporates so that the flow of air can be cooled by the evaporation.

The accumulator 14 is connected to the outlet side of the evaporator 13. The accumulator 14 is a gas-liquid separating means for separating the refrigerant, which has been discharged from the outlet of the evaporator 13, into the gas-phase refrigerant and the liquid-phase refrigerant, and for storing the liquid-phase refrigerant. The gas-phase refrigerant is made to flow out from the accumulator 14 to the suction side of the compressor 10. Due to the foregoing, the accumulator 14 prevents the liquid-phase refrigerant from being sucked into the compressor 10.

The internal heat exchanger 15 exchanges heat between the refrigerant (gas-phase refrigerant) of low temperature and low pressure, which has flowed out from the accumulator 14 so as to be sucked into the compressor 10, and the refrigerant of high temperature and high pressure flowing on the outlet side of the gas cooler 11. Therefore, the low pressure refrigerant passage, in which the refrigerant of low pressure flows, and the high pressure refrigerant passage, in which the refrigerant of high pressure flows, are formed in the internal heat exchanger 15.

Next, explanations will be made into operation of the refrigerating cycle in the device composed as described above. First, the refrigerant is compressed by the compressor 10 and the pressure of the refrigerant is raised. In this case, in a CO₂ cycle, the refrigerant discharged from the compressor 10 is usually compressed to a pressure higher than the critical pressure. Therefore, in the gas cooler 11, while the discharged refrigerant is being maintained in the super-critical state, heat is exchanged between the refrigerant and the outside air.

The refrigerant at high pressure, the temperature of which has been decreased because the heat is radiated from the refrigerant when the refrigerant flows in the gas cooler 11, passes through the high pressure refrigerant passage of the internal heat exchanger 15 and then flows into the expansion valve 12 so that the pressure of the refrigerant can be decompressed, and the refrigerant is put into the gas-liquid two-phase state of gas and liquid in which the temperature and pressure of the refrigerant are low. Next, this refrigerant of low pressure flows into the evaporator 13. In the evaporator 13, the refrigerant of low pressure deprives latent heat for evaporating from a flow of air, which is sent from the interior air conditioning unit 20, so that the liquid-phase refrigerant can be evaporated.

Due to the foregoing, a flow of air from the interior air conditioning unit 20 can be cooled by the evaporator 13. Therefore, a flow of cold air can flow out from the interior air conditioning unit 20 and the vehicle room can be cooled. The refrigerant of low pressure, which has passed through the evaporator 13, passes through the accumulator 14 and the low pressure refrigerant passage of the interior heat exchanger 15 and is sucked into the compressor 10.

In this connection, in the internal heat exchanger 15, heat is exchanged between the refrigerant of low temperature and low pressure on the outlet side of the accumulator 14 and the refrigerant of high temperature and high pressure on the outlet side of the gas cooler 11. Therefore, the enthalpy of the refrigerant on the inlet side of the evaporator 13 becomes lower, than that of a case in which the internal heat exchanger 15 is not set, by the enthalpy of the refrigerant corresponding to a quantity of heat exchanged in the internal heat exchanger 15.

Accordingly, a difference in the enthalpy between the inlet side and the outlet side of the evaporator 13 becomes larger, than that in the case in which the internal heat exchanger 15 is not set, by the decreased enthalpy of the refrigerant at the inlet side of the evaporator. Therefore, the cooling capacity of the evaporator 13 can be enhanced.

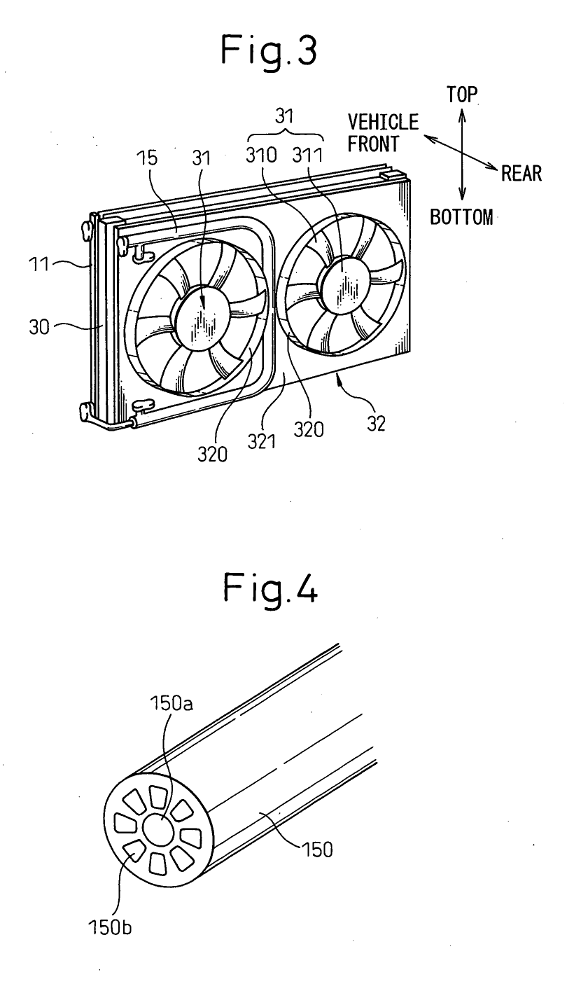

Next, a position at which the internal heat exchanger 15 is mounted will be explained referring to FIGS. 2 and 3. FIG. 2 is a view showing the air conditioner for vehicle use, wherein the view is taken from the side of a vehicle, and FIG. 3 is a view showing the air conditioner for vehicle use, wherein the view is taken from the oblique rear of a vehicle.

A cooling unit for cooling engine E (shown in FIG. 1) of a vehicle is mounted in the engine room of the vehicle. The cooling unit includes: a radiator 30 for cooling the engine; two blowers 31; and a fan shroud 32.

The radiator 30 for cooling the engine is arranged on the rear side of the gas cooler 11 with respect to the vehicle and exchanges heat between the cooling water, which has cooled engine E, and the outside air so as to cool the cooling water.

The blower 31 includes: a fan 310 for generating a current of air; and an electric motor 311 for driving the fan 310. The blower 31 is arranged on the rear side of the radiator 30 for cooling the engine, so that the outside air can be sent to the gas cooler 11 for cooling the refrigerant and the radiator 30 for cooling the engine.

The fan shroud 32 includes: two cylindrical portions 320 surrounding the fan 310; and a substantially plane-shaped flat plate portion 321 arranged round the cylindrical portions 320. The outer circumferential side of the blower 31 is covered with the cylindrical portions 320, and a portion of the core face of the radiator 30 for cooling the engine, which is not opposed to the fan 310, is covered with the flat plate portion 321. Due to the foregoing, a current of air generated by the fan 310 can be guided so that it can pass through the gas cooler 11 for cooling the refrigerant and the radiator 30 for cooling the engine. Further, the fan shroud 32 has a function of holding the electric motor 311.

The internal heat exchanger 15 is arranged in a space on the rear side of the fan shroud 32 with respect to the vehicle and on the outer circumferential side of the blower 31. In other words, the internal heat exchanger 15 is arranged in a space on the rear side of the flat plate portion 321 of the fan shroud 32 with respect to the vehicle and on the outer circumferential side of the cylindrical portions 320 of the fan shroud 32.

The internal heat exchanger 15 is curved into a substantial U-shape, and a linear portion in the intermediate portion of the internal heat exchanger 15 is arranged between the two blowers 31. A linear portion on one end side is arranged in an upper portion of one of the blowers 31, and a linear portion on the other end side is arranged in a lower portion of one of the blowers 31.

In this case, the structure of the heat exchanging section of the internal heat exchanger 15 will be explained below. FIG. 4 is a view showing a sectional structure of the heat exchanging section. The heat exchanging section 150 is made of a single material, the heat conductivity of which is high, such as aluminum alloy. More specifically, the heat exchanging section 150 is made of aluminum alloy and formed into a cylindrical shape by means of extruding or drawing. A large number of passages 150a, 150b are formed in the longitudinal direction of the cylindrical section in such a manner that the passages 150a, 150b penetrate the cylinder.

In the first passage 150a formed at the center, for example, the refrigerant of high temperature flows. In a plurality of the second passages 150b formed round the first passage 150a, for example, the refrigerant of low temperature flows.

According to this embodiment, the internal heat exchanger 15 is arranged in a space on the rear side of the fan shroud 32 with respect to the vehicle and on the outer circumferential side of the blower 31, that is, the space, which is not effectively used in the conventional structure, is utilized. Therefore, even when a new space for arranging the internal heat exchanger 15 is not ensured in the engine room, the internal heat exchanger 15 can be installed in the engine room 15.

Further, the internal heat exchanger 15 is not integrated with the accumulator 14 and the gas cooler 11 for cooling the refrigerant into one body. Therefore, the installation property of the internal heat exchanger 15 can be enhanced without making the accumulator 14 larger and deteriorating the radiating performance of the gas cooler 11 for cooling the refrigerant.

From the viewpoint of facilitating the refrigerant flow, it is preferable that the gas cooler 11 for cooling the refrigerant and the internal heat exchanger 15 are arranged close to each other. According to this embodiment, the gas cooler 11 for cooling the refrigerant and the internal heat exchanger 15 are arranged close to each other since the internal heat exchanger 15 is accommodated in the radiator 30 for cooling the engine and the fan shroud 32 which are integrated with the gas cooler 11 for cooling the refrigerant into one body in many cases.

As the pressure resistance of the heat exchanging section 150, which is formed by means of extruding or drawing, is high, the heat exchanging section 150 is preferably used for the internal heat exchanger 15 to which CO₂ cycle is applied, the refrigerant pressure of which is high.

In this connection, it is unnecessary that the entire internal heat exchanger 15 is arranged in the space on the rear side of the fan shroud 32 with respect to the vehicle and on the outer circumferential side of the blower 31, that is, a portion of the internal heat exchanger 15 may be extended into the engine room. In other words, a portion of the internal heat exchanger 15 may be located at a position outside the plane of projection of the fan shroud 32 when it is viewed from the front of a vehicle.

### Second Embodiment

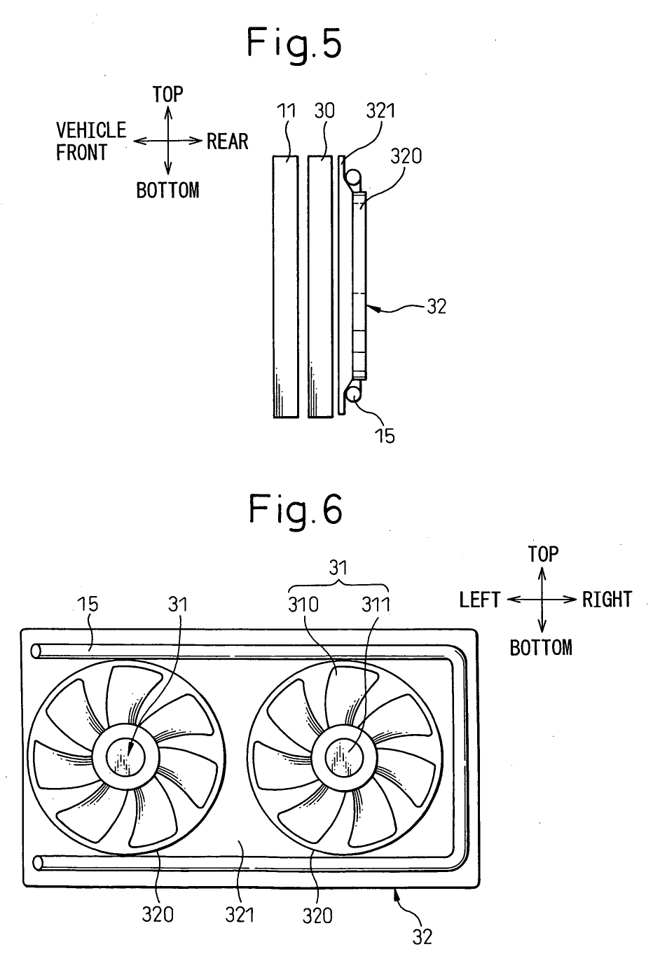

FIG. 5 is a view showing the air conditioner for vehicle use of the second embodiment, wherein the view is taken from the side of a vehicle, and FIG. 6 is a side view showing the right of FIG. 5. Like reference characters are used to indicate like parts in the first and the second embodiment, and explanations with respect to the like parts are omitted here.

As shown in FIGS. 5 and 6, the internal heat exchanger 15 is curved into a substantial U-shape, and a linear portion in the intermediate portion is arranged outside the blower 31 on the plane of projection of the fan shroud 32 in the vehicle width direction. Linear portions arranged in an upper portion and lower portion of the blower 31 are arranged in almost all regions on the plane of projection of the fan shroud 32 in the vehicle width direction. This embodiment is preferably used as method of mounting the internal heat exchanger 15, the length of which is larger.

### Third Embodiment

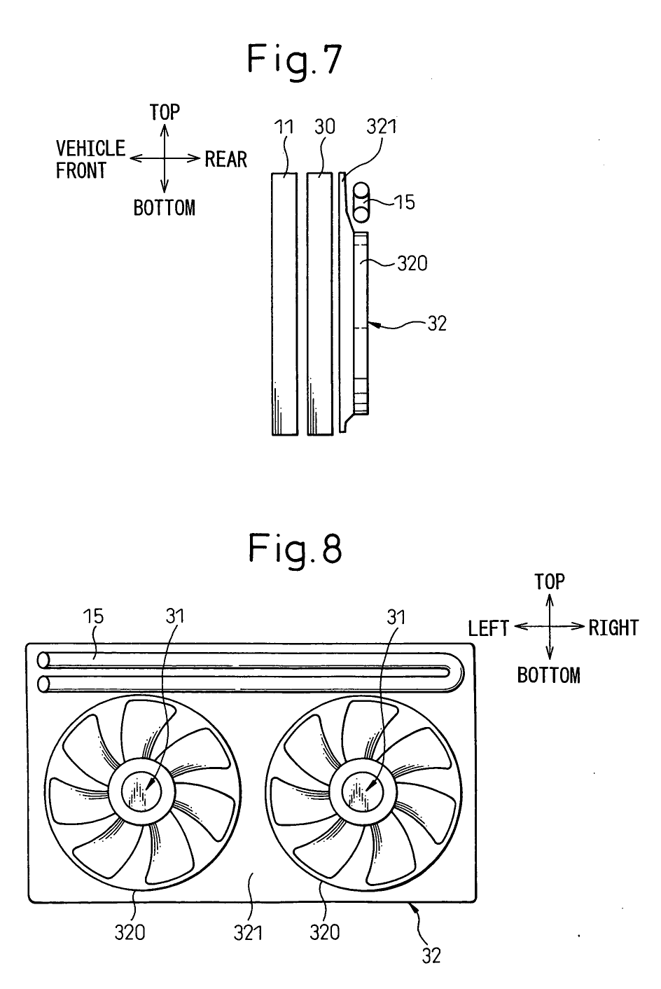

FIG. 7 is a view showing the air conditioner for vehicle use of the third embodiment, wherein the view is taken from the side of a vehicle, and FIG. 8 is a side view showing the right of FIG. 7. Like reference characters are used to indicate like parts in the first and the third embodiment, and the explanations with respect to the like parts are omitted here.

As shown in FIGS. 7 and 8, in the case where a large space is provided in an upper or a lower portion of the blower 31 on the plane of projection of the fan shroud 32, for example, a long and slender internal heat exchanger 15, the shape of which is a U-shape, is arranged in the space.

### Fourth Embodiment

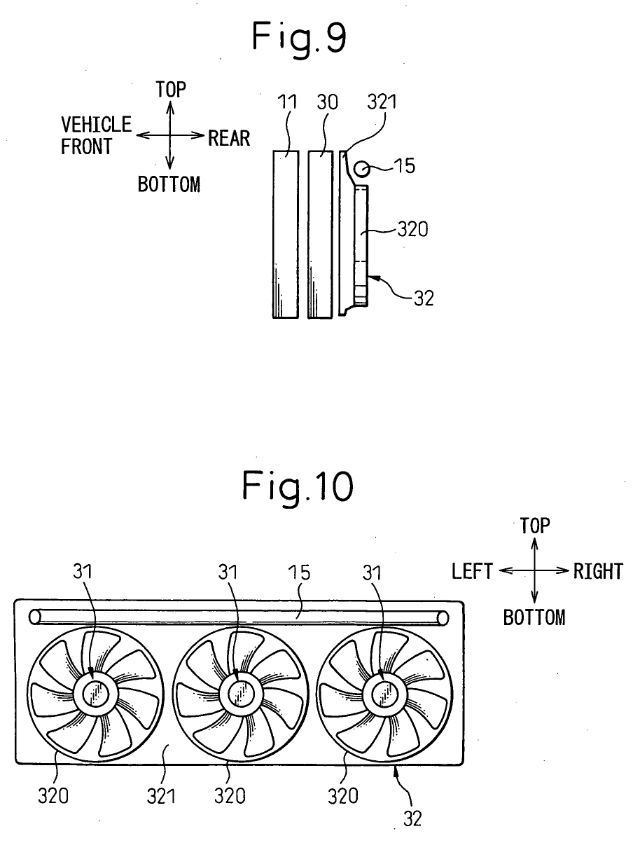

FIG. 9 is a view showing the air conditioner for vehicle use of the fourth embodiment, wherein the view is taken from the side of a vehicle, and FIG. 10 is a side view showing the right of FIG. 9. Like reference characters are used to indicate like parts in the first and the fourth embodiment, and the explanations with respect to the like parts are omitted here.

As shown in FIGS. 9 and 10, in the case where a space is formed only in an upper portion or a lower portion of the blower 31 on the plane of projection of the fan shroud 32, the internal heat exchanger 15 is arranged in this space. To the internal heat exchanger 15 which is long from side to side, this method is effectively applied.

### Fifth Embodiment

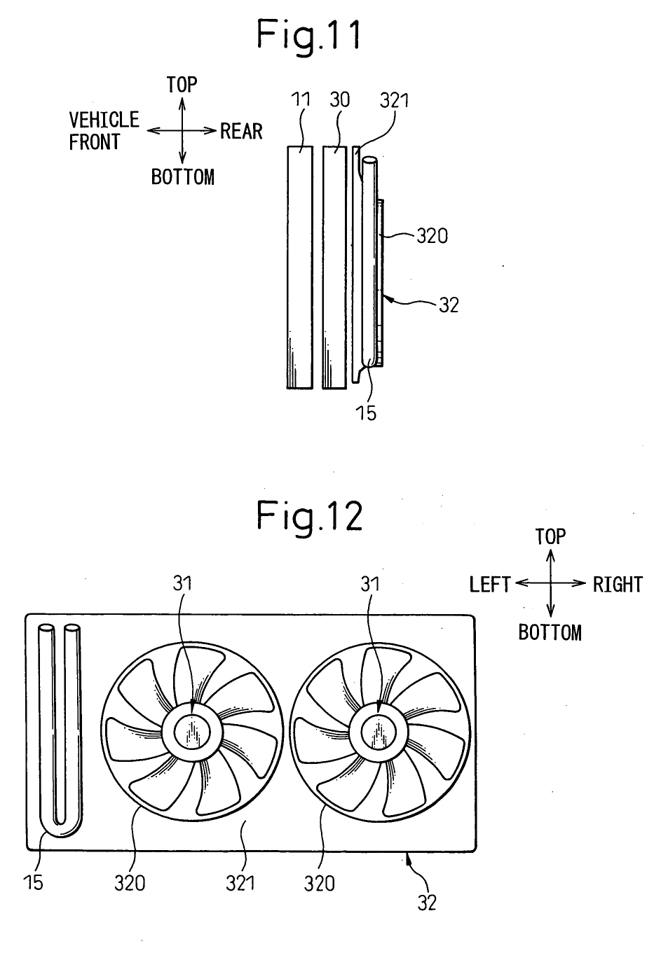

FIG. 11 is a view showing the air conditioner for vehicle use of the fifth embodiment, wherein the view is taken from the side of a vehicle, and FIG. 12 is a side view showing the right of FIG. 11. Like reference characters are used to indicate like parts in the first and the fifth embodiment, and explanations with respect to the like parts are omitted here.

As shown in FIGS. 11 and 12, in the case where a large space is formed outside the blower 31 on the plane of projection of the fan shroud 32 in the width direction of a vehicle, for example, the internal heat exchanger 15, which is curved into a long and slender U-shape, is arranged in the space.

### Sixth Embodiment

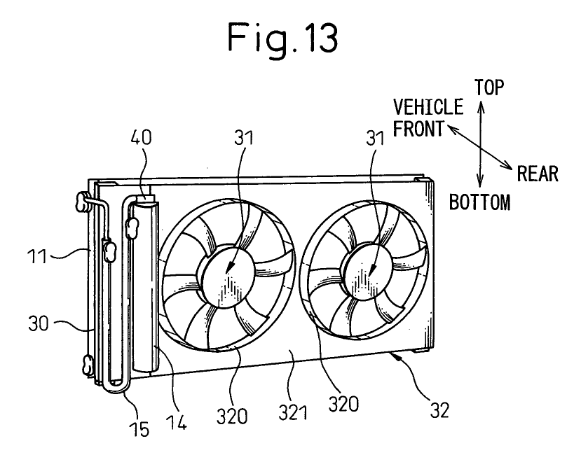

FIG. 13 is a view showing the air conditioner for vehicle use of the sixth embodiment, wherein the view is taken from the oblique rear of a vehicle. Like reference characters are used to indicate like parts in the first and the sixth embodiment, and explanations with respect to the like parts are omitted here.

As shown in FIG. 13, when the accumulator 14 and the internal heat exchanger 15 are arranged outside the blower 31 on the plane of projection of the fan shroud 32 in the width direction of a vehicle, a dead space formed at the rear of the fan shroud 32 can be more effectively utilized.

In this structure, the gas cooler 11 for cooling the refrigerant and the internal heat exchanger 15 are directly connected to each other so as to eliminate the redundant pipes. Further, the accumulator 14 and the internal heat exchanger 15 are directly connected to each other via the connector section 40 for connecting the passages in which the refrigerant flows. Due to the foregoing, the refrigerant at the outlet of the accumulator 15 is directly introduced onto the low pressure side of the internal heat exchanger 15. Therefore, the system can be greatly simplified.

### Seventh Embodiment

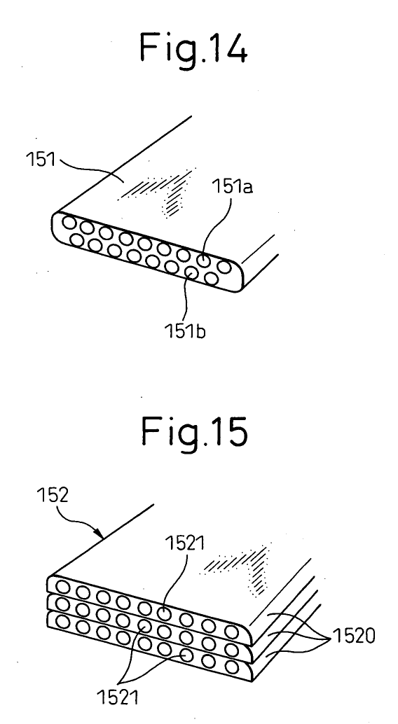

FIG. 14 is a perspective view showing a sectional structure of the heat exchanging section of the air conditioner for vehicle use of the seventh embodiment.

As shown in FIG. 14, the heat exchanging section 151 in the internal heat exchanger 15 is made of aluminum alloy and formed into a plate-shape by means of extruding or drawing, and a large number of passages 151a, 151b are formed penetrating the plate-shaped heat exchanging section 151.

For example, the refrigerant of high temperature flows in the first passage 151a formed in one row (the upper row in FIG. 14), and the refrigerant of low temperature flows in the second passage 151b formed in the other row (the lower row in FIG. 14), and heat is exchanged between the refrigerant of high temperature and the refrigerant of low temperature via the wall face.

### Eighth Embodiment

FIG. 15 is a perspective view showing a sectional structure of the heat exchanging section of the air conditioner for vehicle use of the eighth embodiment.

As shown in FIG. 15, the heat exchanging section 152 in the internal heat exchanger 15 is made of aluminum alloy and composed in such a manner that a plurality of the heat exchanging section composing members 1520 (three heat exchanging section composing members 1520, in this example), which are formed by means of extruding or drawing, are placed on each other and joined.

A large number of passages 1521 are formed in the heat exchanging section composing members 1520. For example, the refrigerant of high temperature flows in the passages 1521 of the central heat exchanging section composing member 1520, and the refrigerant of low temperature flows in the passages 1521 of the heat exchanging section composing members 1520 provided on both sides.

While the invention has been described by reference to specific embodiments chosen for purposes of illustration, it should be apparent that numerous modifications could be made thereto, by those skilled in the art, without departing from the basic concept and scope of the invention.

1. An air conditioner for vehicle use mounted on a vehicle,
the vehicle including: a radiator for cooling coolant by exchanging heat between the coolant, which has cooled a water-cooled engine, and the outside air; a blower for generating a current of air, arranged on the rear side of the radiator with respect to the vehicle; and a fan shroud, which covers an outer circumferential side of the blower, for guiding the current of air so that the current of air generated by the blower can pass through the radiator,
the air conditioner for vehicle comprising: a compressor for sucking and compressing refrigerant in a refrigerating cycle; a gas cooler for cooling refrigerant by exchanging heat between the refrigerant, which has been discharged from the compressor, and the outside air; and an internal heat exchanger for exchanging heat between the refrigerant, which has passed through the gas cooler, and the refrigerant before it is sucked into the compressor, wherein
at least a portion of the internal heat exchanger is arranged in a space on the rear side of the fan shroud with respect to the vehicle and on the outer circumferential side of the blower.

2. An air conditioner for vehicle use according to claim 1, wherein a plurality of blowers are provided, and at least a portion of the internal heat exchanger is arranged between the plurality of blowers.

3. An air conditioner for vehicle use according to claim 1, wherein at least a portion of the internal heat exchanger is arranged outside the blower in the width direction of the vehicle.

4. An air conditioner for vehicle use according to claim 1, wherein at least a portion of the internal heat exchanger is arranged in an upper portion or a lower portion of the blower.

5. An air conditioner for vehicle use according to claim 1, wherein the internal heat exchanger includes a heat exchanging section having a passage, in which the refrigerant of high temperature flows, and also having a passage, in which the refrigerant of low temperature flows, and the heat exchanging section is made by means of extruding or drawing.

6. An air conditioner for vehicle use according to claim 5, wherein the heat exchanging section is formed into a cylindrical shape.

7. An air conditioner for vehicle use according to claim 5, wherein the heat exchanging section is formed into a plate shape.

8. An air conditioner for vehicle use according to claim 5, wherein the heat exchanging section is composed of a plurality of plate-shaped heat exchanging section composing members which are joined to each other.

9. An air conditioner for vehicle use according to claim 1, further comprising an accumulator in which refrigerant is separated into gas-phase refrigerant and liquid-phase refrigerant and the separated liquid-phase refrigerant is stored, wherein at least one portion of the accumulator is arranged in a space on the rear side of the fan shroud with respect to the vehicle and on the outer circumferential side of the blower.

10. An air conditioner for vehicle use according to claim 9, wherein the accumulator and the internal heat exchanger are directly connected to each other by a connector.

11. An air conditioner for vehicle use according to claim 1, wherein the refrigerant is carbon dioxide.

12. An air conditioner for vehicle use according to claim 1, wherein the radiator for cooling the engine is arranged on the rear side of the gas cooler for cooling the refrigerant with respect to the vehicle.

13. An air conditioner for vehicle use according to claim 1, wherein the fan shroud includes: a cylindrical portion surrounding the fan; and a substantially flat plate portion provided round the cylindrical portion.
